(19) United States
(12) Patent Application Publication
(10) Pub. No.: US 2007/0230190 A1
(43) Pub. Date: Oct. 4, 2007

(54) Lighting Device

(76) Inventor: Satoshi SASAKI, Tokyo (JP)

Correspondence Address: CERMAK KENEALY & VAIDYA, LLP, 515 EAST BRADDOCK RD SUITE B, Alexandria, VA, 22314, US

(21) Appl. No.: 11/692,919

(22) Filed: Mar. 29, 2007

(30) Foreign Application Priority Data
Mar. 29, 2006 (JP) 2006-090949

(51) Int. Cl. F21V 5/00

(52) U.S. Cl. 362/336; 362/332; 362/335

(57) ABSTRACT

A lighting device such as a vehicle lighting device can be configured to be easily adapted to design changes in order to comply with various required or desired luminous intensity distributions. Light emitted from a light source at a large angle with respect to a main optical axis of the light source is more significantly condensed closer to the main optical axis than is the light emitted from the light source at a relatively smaller angle with respect to the main optical axis of the light source. The lighting device can include a lens which has a first lens cut and a second lens cut. The first lens cut can allow light emitted from the light source at a relatively smaller angle with respect to the main optical axis of the light source to pass therethrough. The second lens cut is arranged outside the first lens cut so as to condense light, emitted from the light source at a larger angle, close to the main optical axis of the light source.

This application claims the priority benefit under 35 U.S.C. § 119 of Japanese Patent Application No. 2006-90949 filed on Mar. 29, 2006, which is hereby incorporated in its entirety by reference.

### BACKGROUND

1. Technical Field

The presently disclosed subject matter relates to a lighting device which is configured such that light emitted from a light source at a larger angle with respect to the main optical axis of the light source is condensed more than light emitted from the light source at emission angles within a lesser predetermined range with respect to the main optical axis of the light source. In particular, the disclosed subject matter relates to a lighting device which is miniaturized and can be easily adapted to design changes in order to comply with various required or desired luminous intensity distributions. The lighting device can be applied to a vehicle lighting device and other lighting applications.

2. Description of the Related Art

Conventionally, a vehicle lighting device is known which is configured such that light emitted from a light source (being, for example, a light emitting diode) at a relatively large angle with respect to the main optical axis of the light source is condensed more than light emitted from the light source at a relatively smaller angle with respect to the main optical axis of the light source. Such a vehicle lighting device is disclosed in, for example, Japanese Patent Laid-Open Publication No. 2002-231013.

In the vehicle lighting device disclosed in Japanese Patent Laid-Open Publication No. 2002-231013, light emitted from a light source at a relatively small angle with respect to the main optical axis of the light source is not reflected, but irradiated as a direct light. Light emitted at a relatively larger angle with respect to the main optical axis is condensed by a reflector (or a reflecting member) provided around the light source to be directed along the main optical axis for irradiation.

The vehicle lighting device having this configuration can provide a required or desired luminous intensity distribution (or light distribution).

Accordingly, when the vehicle lighting device is designed to provide a required or desired luminous intensity distribution, in order to condense the light emitted at a relatively large angle with respect to the main optical axis, a reflector is inevitably installed around the light source.

This typically requires space for installing the reflector around the light source, which can result in a problem where the entire size of such a vehicle lighting device becomes unnecessarily large. Furthermore, the space between adjacent light sources are sometimes widened to a certain extent in order to secure space for installing respective reflectors.

In addition to this, if the light source is replaced with another light source due to a design change, the reflector installed in a narrow space around the light source is inevitably changed in design in order to provide a required or desired luminous intensity distribution (light distribution).

A description will now be given regarding the technology relating to conventional lighting devices with reference to the accompanying drawings.

FIG. 1 is a diagram illustrating a light distribution standard for typical vehicle lighting devices. In FIG. 1, the letter “H” represents a horizontal line whereas the letter “V” represents a vertical line crossing the main optical axis of the vehicle lighting device. The symbol “5° U” represents a line located above with respect to the horizontal line by an angle of 5°, and the symbol “5° D” represents a line located below with respect to the horizontal line by an angle of 5°. The symbol “10° R” represents a line located rightward by an angle of 10° with respect to the main optical axis of the vehicle lighting device, and the symbol “10° L” represents a line located leftward by an angle of 10° with respect to the main optical axis of the vehicle lighting device.

For example, in accordance with the light distribution standard for a rear fog lamp, the luminous intensity on the lines HL and VL in FIG. 1 should be 150 cd or more. Furthermore, the luminous intensity within the area defined by the dotted line in FIG. 1 should be set in the range of from 75 cd to 300 cd.

FIG. 2 is a cross sectional view of a vehicle lighting device in the technical field related to the disclosed subject matter. In FIG. 2, the letter “S” represents an incandescent source, and the letter “CL” represents the main optical axis of the light source S. Furthermore, the letter “R” represents a reflector for reflecting part of light emitted from the light source S, “LS” represents a lens, and LC1, LC2, LC3, and LC4 represent lens cuts formed on the lens LS.

As shown in FIG. 2, light A′ emitted from the light source S is refracted by means of the lens cut LC1 and passes through the lens cut LC1 to be irradiated as diffused light A in the illumination direction (upper side in FIG. 2). Light B′ emitted from the light source S is refracted by means of the lens cut LC2 and passes through the lens cut LC2 to be irradiated as diffused light B in the illumination direction.

Furthermore, light C″ emitted from the light source S is reflected by the reflector R to become reflected light C′ which is approximately parallel to the main optical axis CL of the light source S. Then, the reflected light C′ is refracted by means of the lens cut LC3 and passes through the lens cut LC3 to be irradiated as diffused light C in the illumination direction.

Furthermore, light D″ emitted from the light source S is reflected by the reflector R to become reflected light D′ which is approximately parallel to the main optical axis CL of the light source S. Then, the reflected light D′ is refracted by means of the lens cut LC4 and passes through the lens cut LC4 to be irradiated as diffused light D in the illumination direction.

FIGS. 3A and 3B are diagrams for illustrating luminous intensity distributions CA, CB, CC, and CD of light A, B, C, and D, respectively. FIG. 3A separately shows the luminous intensity distributions CA, CB, CC, and CD overlapped with each other. FIG. 3B is a diagram showing a total luminous intensity distribution obtained by synthesizing the luminous intensity distributions CA, CB, CC, and CD.

The vertical axis represents a luminous intensity and the horizontal axis represents a horizontal angle (being an angle on the horizontal line H as shown in FIG. 1) with respect to the main optical axis CL of the light source S shown in FIG. 2. For example, zero (0) degree on the horizontal line H corresponds to the points on the main optical axis CL of the light source S.

In this vehicle lighting device, an incandescent lamp having a filament is used as a light source S. In this instance, the luminous intensities of lights A′, B′, C″, and D″ emitted from the light source S are almost uniform, and accordingly, the luminous intensity of lights A, B, C, and D which have passed through the lens LS are also uniform.

As a result, in this vehicle lighting device, the luminous intensity distribution CB of the light B is almost the same as that obtained by shifting the luminous intensity distribution CA of the light A rightward. Furthermore, the luminous intensity distribution CC of the light C is almost the same as that obtained by shifting the luminous intensity distribution CB of the light B rightward. Also, the luminous intensity distribution CD of the light D is almost the same as that obtained by shifting the luminous intensity distribution CC of the light C rightward.

As a result, the luminous intensity in the vicinity of the right edge of the specified range is as high as that around the center area (at an angle of 0°) of the specified range as shown in FIG. 3B, therefore satisfying the standard value.

A description will now be given regarding another technology in the same technical field of the disclosed subject matter. The vehicle lighting device described above used an incandescent lamp as a light source S as shown in FIG. 2. In this conventional vehicle lighting device, an LED having a high directivity is now used as a light source.

FIG. 4 shows a luminous intensity distribution of the LED serving as a light source. In FIG. 4, the horizontal axis represents an angle with respect to the main optical axis of the LED, and the vertical axis represents a percentage of the luminous intensity of the LED. In particular, FIG. 4 shows the relationship between the angle with respect to the main optical axis of the LED and the luminous intensity percentage when the luminous intensity on the main optical axis of the LED is assumed to be 100%. As shown in FIG. 4, the LED shows its luminous intensity distribution with a sharp peak on the main optical axis, and therefore, the luminous intensity at a larger angle with respect to the main optical axis is abruptly decreased.

FIG. 5 is a cross sectional view of part of a vehicle lighting device in the technical field related to the disclosed subject matter. The shown light source S is an LED.

In this vehicle lighting device of FIG. 5, light A′ is emitted from the light source S at a relatively small angle with respect to the main optical axis CL of the light source S. This light A′ is refracted by means of the lens cut LC1 and passes through the lens cut LC1 to be irradiated as light A in the illumination direction (upper side in FIG. 5).

Furthermore, light B′ is emitted from the light source S, and is refracted by means of the lens cut LC2 and passes through the lens cut LC2 to be irradiated as light B in the illumination direction. Specifically, the angle formed between the main optical axis CL and the light B′ is larger than that formed between the axis CL and the light A′. Furthermore, the angle at which the light B′ is refracted by means of the lens cut LC2 is larger than that at which the light A′ is refracted by means of the lens cut LC1. In other words, the light B′ emitted from the light source S at the larger angle with respect to the main optical axis CL than the light A′ is more significantly condensed close to the main optical axis CL of the light source S than the light A′ is.

Furthermore, light C′ is emitted from the light source S, and is refracted by means of the lens cut LC3 and passes through the lens cut LC3 to be irradiated as light C in the illumination direction. Specifically, the angle formed between the main optical axis CL and the light C′ is larger than that formed between the axis CL and the light B′. Furthermore, the angle at which the light C′ is refracted by means of the lens cut LC3 is larger than that at which the light B′ is refracted by means of the lens cut LC2. In other words, the light C′ emitted from the light source S at the larger angle with respect to the main optical axis CL than the light B′ is more significantly condensed close to the main optical axis CL of the light source S than the light B′ is.

Furthermore, light D′ is emitted from the light source S, and is refracted by means of the lens cut LC4 and passes through the lens cut LC4 to be irradiated as light D in the illumination direction. Specifically, the angle formed between the main optical axis CL and the light D′ is larger than that formed between the axis CL and the light C′. Furthermore, the angle at which the light D′ is refracted by means of the lens cut LC4 is larger than that at which the light C′ is refracted by means of the lens cut LC3. In other words, the light D′ emitted from the light source S at the larger angle with respect to the main optical axis CL than the light C′ is more significantly condensed close to the main optical axis CL of the light source S than the light C′ is.

FIGS. 6A and 6B are diagrams illustrating luminous intensity distributions CA, CB, CC, and CD of light A, B, C, and D shown in FIG. 5, respectively. FIG. 6A separately shows the luminous intensity distributions CA, CB, CC, and CD overlapped with each other. FIG. 6B is a diagram showing a total luminous intensity distribution obtained by synthesizing the luminous intensity distributions CA, CB, CC, and CD.

In these drawings, the vertical axis represents a luminous intensity and the horizontal axis represents a horizontal angle (being an angle on the horizontal line H as shown in FIG. 1) with respect to the main optical axis CL of the light source S (see FIG. 5). For example, zero (0) degree on the horizontal line H corresponds to the points on the main optical axis CL of the light source S.

In this vehicle lighting device, an LED having a high-level directivity is used as a light source S. Accordingly, as shown in FIGS. 4 and 5, the luminous intensities of the light B′, C′, and D′ which are emitted from the light source S at a relatively large angle with respect to the axis CL are significantly decreased as compared to the luminous intensity of the light A′ which is emitted from the light source S at a relatively smaller angle with respect to the main optical axis of the light source S.

In this instance, as shown in FIG. 5, the width of the lens cut LC1 through which the high luminous intensity light A′ passes is almost the same as those of the lens cuts LC2, LC3, and LC4 through which the corresponding low luminous intensity light B′, C′, and D′ pass, respectively.

Furthermore, as shown in FIG. 6A, the luminous intensity distribution CB of the light B is formed on the right side of the luminous intensity distribution CA of the light A. Furthermore, the luminous intensity distribution CC of the light C is formed on the right side of the luminous intensity distribution CB of the light B. Also, the luminous intensity distribution CD of the light D is formed on the right side of the luminous intensity distribution CC of the light C.

Namely, as shown in FIG. 6A, the luminous intensity distribution CB of the light B is almost the same as that obtained by reducing the luminous intensity distribution CA of the light A by 50% and shifting it rightward. Furthermore, the luminous intensity distribution CC of the light C is almost the same as that obtained by reducing the luminous intensity distribution CB of the light B and shifting it rightward. Also, the luminous intensity distribution CD of the light D is almost the same as that obtained by reducing the luminous intensity distribution CC of the light C and shifting it rightward.

As a result, the luminous intensity in the vicinity of the right edge of the specified range is insufficient in spite of unnecessarily high luminous intensity around the center area (at an angle of 0°) of the specified range as shown in FIG. 6B. Accordingly, the standard value cannot be satisfied. In other words, as shown in FIGS. 5 and 6B, the luminous intensities of the light C and D emitted at relatively large angles with respect to the main optical axis of the light source S are insufficient in spite of the unnecessarily high luminous intensity synthesized by the light A and B emitted along or closer to the main optical axis CL of the light source S.

### SUMMARY

In view of the above-described and other characteristics and problems, the presently disclosed subject matter has been developed to provide a lighting device such as a vehicle lighting device in which the space between adjacent light sources can be narrowed and which can be entirely miniaturized.

The presently disclosed subject matter can also provide a lighting device such as a vehicle lighting device which can be easily adapted to design changes in order to comply with various required or desired luminous intensity distribution.

According to one aspect of the presently disclosed subject matter a lighting device can include: a light source having a main optical axis; and a lens having a first lens cut and a second lens cut formed thereon, the first lens cut allowing first light emitted from the light source at emission angles within a predetermined range with respect to the main optical axis to pass therethrough, the second lens cut allowing second light, emitted from the light source at a larger emission angle with respect to the main optical axis than the first light, to pass therethrough. In this case, the second lens cut can be configured to provide a larger condensing degree to the second light received from the light source than the first lens cut provides to the first light received from the light source.

According to this aspect, the second light emitted from the light source at a relatively large angle with respect to the main optical axis of the light source is condensed not by a reflector or the like disposed around the light source, but by the second lens cut of the lens arranged on the main optical axis of the light source to be closer to the main optical axis.

Therefore, it is not necessary to provide a reflecting member around the light source. As a result, the space around the light source can be reduced. This can decrease the distance between adjacent light sources, thereby miniaturizing the entire lighting device.

Furthermore, in comparison to devices that use a reflector, the lighting device can be easily adapted to design changes in order to comply with various required or desired luminous intensity distributions.

In the above-described lighting device, the lens can have a third lens cut formed outside the second lens cut, and the third lens cut can provide a larger condensing degree than that of the second lens cut.

In the disclosed subject matter, the term “condensing degree” means the degree in which light having passed through the lens (lens cut) is condensed in accordance with the refractive index of the lens material and the refractive index determined by the shape of the lens cut.

In this configuration, the relatively low luminous intensity light which has passed through the second lens cut is overlapped with the relatively low luminous intensity light which has passed through the third lens cut. Furthermore, the second and third lens cuts can be configured such that the light which has passed through the second lens cut and the light which has passed through the third lens cut cross each other. Specifically, the second and third lens cuts can be configured such that the outer edge of the light which has passed through the third lens cut is included within the outer edge of the light which has passed through the second lens cut.

As a result, the relatively low luminous intensity light which has passed through the second lens cut and the relatively low luminous intensity light which has passed through the third lens cut overlap each other to increase the luminous intensity at that overlapped area.

In the above-described lighting device, the light source can emit a relatively high luminous intensity light around the main optical axis of the light source, and is configured such that the larger the angle at which the light is emitted with respect to the optical axis, the lower the luminous intensity of light from the light source is emitted. In this case, the width of the first lens cut through which the relatively high luminous intensity light passes can be wider than those of the second and third lens cuts through which relatively low luminous intensity light pass.

In other words, the width of the first lens cut through which the relatively high luminous intensity light passes is wider than those of the second and third lens cuts through which relatively low luminous intensity light passes so that the high luminous intensity light does not enter the boundaries of adjacent lens cuts.

As a result, reduction of the light utilization efficiency of the light source due to high luminous intensity light entering the boundaries of adjacent lens cuts and being irregularly reflected can be reduced.

In other words, the light utilization efficiency of the light source can be improved as compared to the case where the lens cut through which a high luminous intensity light passes is relatively narrow.

In the above-described lighting device, the second and third lens cuts can be configured such that the light which has passed through the second and third lens cuts is not directed to the center of the light which has passed through the first lens cut, but is directed to the outer edge of the light which has passed through the first lens cut.

Specifically, the second and third lens cuts can be configured such that the peaks of the luminous intensity distribution curves of the light which has passed through the second and third lens cuts is not coincident with the peak of the luminous intensity distribution curve of the light which has passed through the first lens cut, but is located at position(s) different from the peak of the luminous intensity distribution curve of the light which has passed through the first lens cut (for example, a bottom area of the curve).

As a result, insufficiency of luminous intensity of light emitted at a large angle with respect to the main optical axis of the light source can be prevented in spite of the unnecessarily high luminous intensity of the light emitted along or close to the main optical axis of the light source.

In other words, even when a light source which has a high directivity is used, insufficiency of the luminous intensity of the light emitted at a larger angle with respect to the main optical axis of the light source can be prevented in spite of the unnecessarily high luminous intensity of the light emitted along or closer to the main optical axis of the light source.

### BRIEF DESCRIPTION OF THE DRAWINGS

These and other characteristics, features, and advantages of the disclosed subject matter will become clear from the following description with reference to the accompanying drawings, wherein:

FIG. 1 is a diagram illustrating a light distribution standard of typical vehicle lighting devices;

FIG. 2 is a cross sectional view of a vehicle lighting device in the technical field related to the disclosed subject matter;

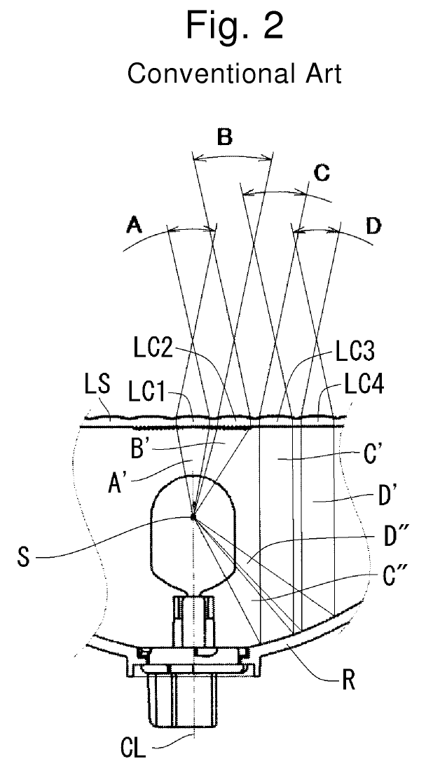

FIGS. 3A and 3B are diagrams illustrating luminous intensity distributions CA, CB, CC, and CD of light A, B, C, and D from FIG. 2, respectively;

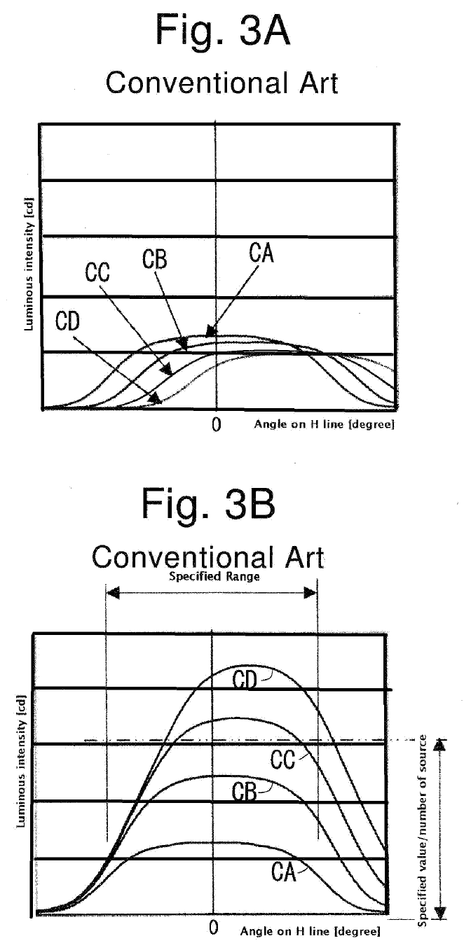

FIG. 4 is a diagram illustrating a luminous intensity distribution for an LED serving as a light source used in a vehicle lighting device in the technical field related to the disclosed subject matter;

FIG. 5 is a cross sectional view of part of a vehicle lighting device in the technical field related to the disclosed subject matter;

FIGS. 6A and 6B are diagrams illustrating luminous intensity distributions CA, CB, CC, and CD of light A, B, C, and D shown in FIG. 5, respectively;

FIG. 7 is a perspective view of parts of an exemplary vehicle lighting device made in accordance with principles of the disclosed subject matter;

FIG. 8 is a view showing a lens LS of the vehicle lighting device of FIG. 7 when viewed from the light source side;

FIG. 9 is a cross sectional view showing the light source S and the lens LS of the vehicle lighting device of FIG. 7;

FIGS. 10A and 10B are diagrams illustrating luminous intensity distributions C1, C2, and C3 of light L1, L2, and L3 shown in FIG. 9, respectively;

FIG. 11 is a cross sectional view showing the light source S and the lens LS of the vehicle lighting device similar to FIG. 9;

FIGS. 12A and 12B are diagrams illustrating the luminous intensity distribution C1 and luminous intensity distributions C4 and C5 of light L4 and L5 of FIG. 11, respectively;

FIG. 13 is a diagram illustrating a luminous intensity distribution of another example of a vehicle lighting device made in accordance with principles of the disclosed subject matter; and

FIG. 14 is a view showing a lens LS′ of another example of a vehicle lighting device made in accordance with principles of the disclosed subject matter when viewed from the light source side.

### DETAILED DESCRIPTION OF EXEMPLARY EMBODIMENTS

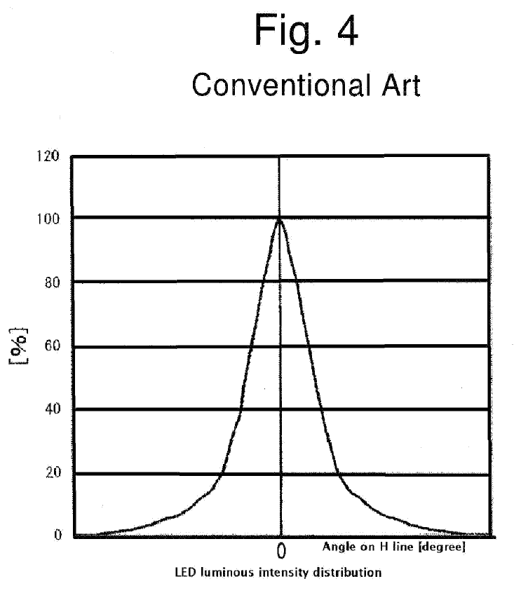

A description will now be given of exemplary embodiments made in accordance with principles of the presently disclosed subject matter with reference to the accompanying drawings. A first exemplary embodiment of a vehicle lighting device of the disclosed subject matter will be described. In this vehicle lighting device, an LED having a high directivity is used as a light source. Accordingly, as shown in FIG. 4, a typical LED shows its luminous intensity distribution with a sharp peak on the main optical axis, and therefore, the luminous intensity at a larger angle with respect to the main optical axis is abruptly decreased.

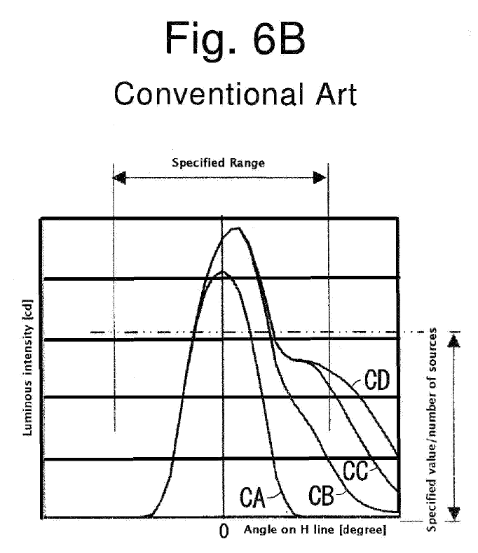

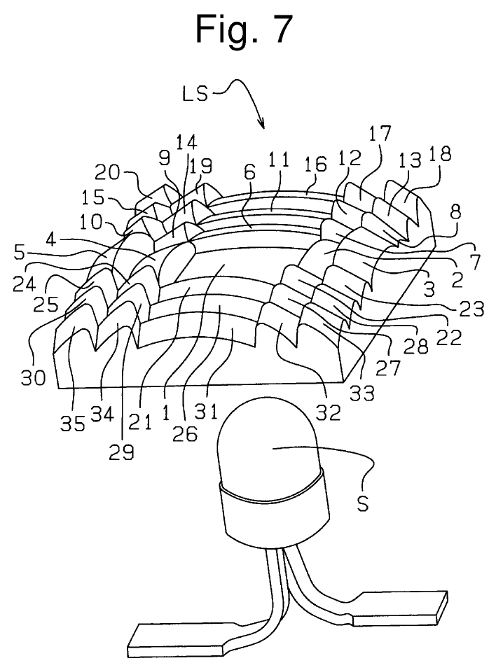

FIG. 7 is a perspective view of parts of the exemplary vehicle lighting device made in accordance with principles of the disclosed subject matter. FIG. 8 is a view showing a lens LS of the vehicle lighting device of FIG. 7 when viewed from the light source side.

The vehicle lighting device can include a lens LS having thirty five (35) lens cuts 1 through 35 formed thereon as shown in FIGS. 7 and 8. Specifically, the lens cuts 2, 22, 21, 24, 4, 9, 6, and 7 are arranged around the lens cut 1. The lens cuts 3, 23, 28, 27, 26, 29, 30, 25, 5, 10, 15, 14, 11, 12, 13, and 8 are arranged further outside the lens cuts listed immediately above. The lens cuts 18, 17, 16, 19, and 20 and the lens cuts 33, 32, 31, 34, and 35 are arranged further outside the lens cuts listed above in an upward and downward direction, respectively.

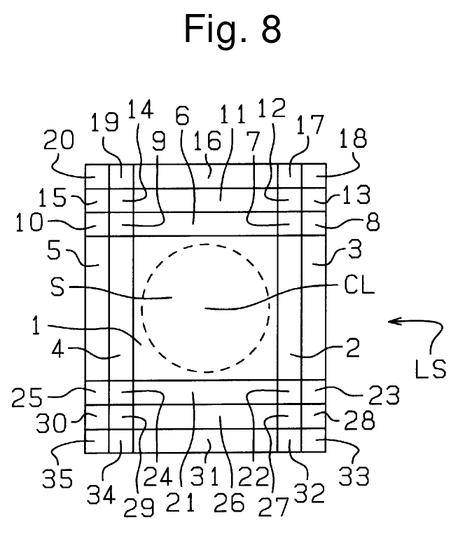

FIG. 9 is a cross sectional view showing the light source S and the lens LS of the vehicle lighting device of FIG. 7. As shown in FIGS. 7 to 9, the width of the lens cut 1 is wider than those of the lens cuts 2, 3, 4, and 5.

In the vehicle lighting device in accordance with the exemplary embodiment of FIG. 7, as shown in FIG. 9, light L1′ is emitted from the light source S at a relatively small angle with respect to the main optical axis CL of the light source S, or at emission angles within a predetermined range. This light L1′ is refracted by means of the lens cut 1 and passes through the lens cut 1 to be irradiated as light L1 in the illumination direction (upper side in FIG. 9). In accordance with the disclosed subject matter, the range of the emission angle at which the light L1′ is emitted may be +/−30 degrees with respect to the main optical axis CL. In a case where a light source with a high directivity such as an LED light source is used, the light emitted within this angular range may have a certain high luminous intensity. Accordingly, the light that is emitted from the high directivity light source enters the lens cut 1 and is not refracted too much, thereby satisfying a required or desired luminous intensity distribution.

Furthermore, light L2′ is emitted from the light source S, and is refracted by means of the lens cut 2 and passes through the lens cut 2 to be irradiated as light L2 in the illumination direction. The angle formed between the main optical axis CL and the light L2′ is larger than that formed between the axis CL and the light L1′. Furthermore, the angle at which the light L2′ is refracted by means of the lens cut 2 is larger than that at which the light L1′ is refracted by means of the lens cut 1. In other words, the light L2′ emitted from the light source S at the larger angle with respect to the main optical axis CL than that of the light L1′ is more significantly condensed close to the main optical axis CL of the light source S than is the light L1′.

Furthermore, light L3′ is emitted from the light source S, and is refracted by means of the lens cut 3 and passes through the lens cut 3 to be irradiated as light L3 in the illumination direction. Specifically, the angle formed between the main optical axis CL and the light L3′ is larger than that formed between the axis CL and the light L2′. Furthermore, the angle at which the light L3′ is refracted by means of the lens cut 3 is larger than that at which the light L2′ is refracted by means of the lens cut 2. In other words, the light L3′ emitted from the light source S at a larger angle with respect to the main optical axis CL than that of the light L2′ is more significantly condensed close to the main optical axis CL of the light source S than is the light L2′.

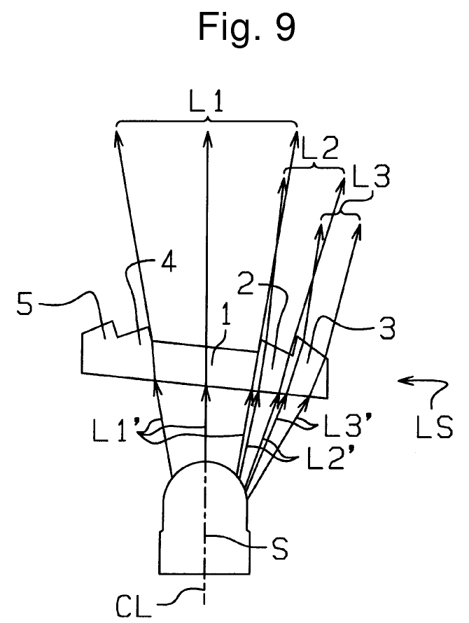

FIGS. 10A and 10B are diagrams illustrating luminous intensity distributions C1, C2, and C3 of light L1, L2, and L3 shown in FIG. 9, respectively. FIG. 10A separately shows the luminous intensity distributions C1, C2, and C3 overlapped with each other. FIG. 10B is a diagram showing a total luminous intensity distribution obtained by synthesizing the luminous intensity distributions C1, C2, and C3.

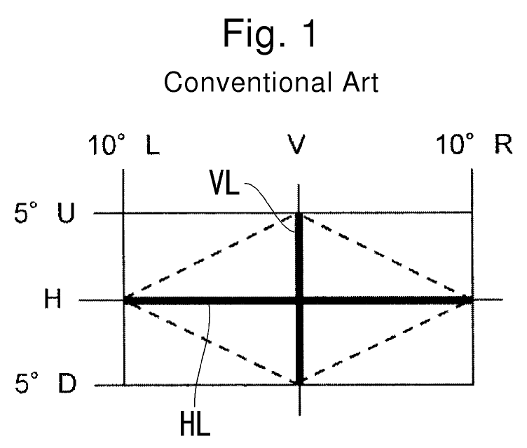

In these drawings, the vertical axis represents a luminous intensity and the horizontal axis represents a horizontal angle (being an angle on the horizontal line H as shown in FIG. 1) with respect to the main optical axis CL of the light source S (see FIG. 9). For example, zero (0) degree on the horizontal line H corresponds with the points on the main optical axis CL of the light source S.

In the vehicle lighting device of FIG. 7, an LED having a high-level directivity is used as a light source S. Accordingly, as shown in FIGS. 4 and 9, as compared to the luminous intensity of the light L1′ which is emitted from the light source S at a relatively small angle (i.e., at emission angles within a predetermined range) with respect to the main optical axis of the light source S, the luminous intensities of the light L2′ and L3′ which is emitted from the light source S at a relatively larger angle with respect to the axis CL is significantly decreased.

In the vehicle lighting device as shown in FIG. 9, the lens can have a lens cut 3 formed outside the lens cut 2, and the lens cut 3 can provide a larger condensing degree than that of the lens cut 2. In other words, the relatively low luminous intensity light L2 which has passed through the lens cut 2 is overlapped with the relatively low luminous intensity light L3 which has passed through the lens cut 3. Accordingly, the luminous intensity distribution C2 of the light L2 is overlapped with the luminous intensity distribution C3 of the light L3 as shown in FIG. 10A.

Specifically, the lens cuts 2 and 3 can be configured such that the light L2 which has passed through the lens cut 2 and the light L3 which has passed through the lens cut 3 cross each other. More specifically, the lens cuts 2 and 3 can be configured such that the outer edge of the light L3 which has passed through the lens cut 3 is included within the outer edge of the light L2 which has passed through the lens cut 2. As shown in FIG. 10A, the luminous intensity distribution C3 of the light 3 is located within the area of the luminous intensity distribution C2 of the light 2.

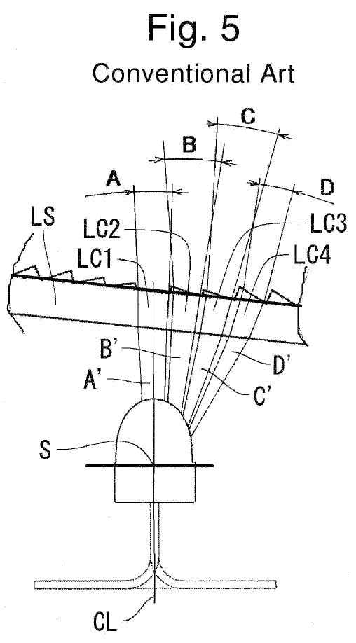

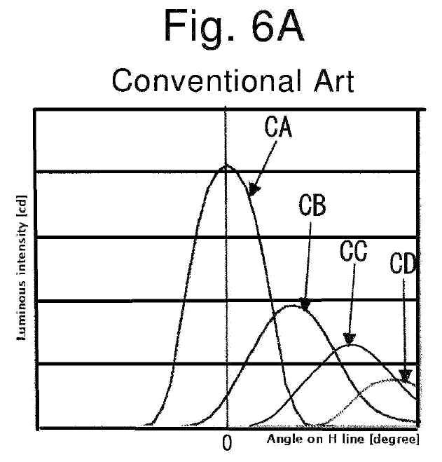

In the conventional vehicle lighting device as shown in FIGS. 5 and 6, the light C with a relatively low luminous intensity which has passed through the lens cut LC3 and the outside light D also with a relatively low luminous intensity which has passed through the lens cut LC4 do not appropriately overlap with each other for irradiation. In other words, the light C and light D do not overlap each other for the purpose of providing better irradiation characteristics in the specified or desired range of irradiation for the lighting device.

Conversely, in the vehicle lighting device of FIG. 9, the light L2 and the light L3 emitted from the light source S with respective larger angles to the main optical axis CL can increase the luminous intensity at the area to be irradiated (C2+C3) as shown in FIG. 10B.

Furthermore, the vehicle lighting device of FIG. 9 can also be different from the conventional vehicle lighting device in that the width of the lens cut 1 through which the relatively high luminous intensity light L1′ passes can be wider than those of the lens cuts 2 and 3 through which relatively low luminous intensity light L2′ and L3′ pass.

In the conventional vehicle lighting device shown in FIGS. 5 and 6, the high luminous intensity light A and B may enter the boundaries of the adjacent two lens cuts LC1 and LC2. In order to prevent the high luminous intensity light from entering the boundaries, in the vehicle lighting device of FIG. 9, the width of the lens cut 1 is wider than those of the lens cuts 2 and 3.

In the conventional vehicle lighting device as shown in FIGS. 5 and 6, the high luminous intensity light A′ and B′ are incident on the boundary between the adjacent two lens cuts LC1 and LC2 and the incident light is irregularly reflected. In this case, the light utilization efficiency is reduced to a certain level. However, in the vehicle lighting device of FIG. 9, this reduction in light utilization efficiency can be partially or totally prevented. In other words, as compared to the conventional vehicle lighting device (as shown in FIGS. 5 and 6) in which the widths of the lens cuts LC1 and LC2 (through which the high luminous intensity light A′ and B′ is allowed to pass) are set relatively narrower, the utilization efficiency of light L1′ from the light source S is increased (see FIG. 9).

Furthermore, the lens cuts 2 and 3 are configured such that the light L2 and L3 which has passed through the lens cuts 2 and 3, respectively, is not directed toward the center of the light L1 which has passed through the lens cut 1 (center of the luminous intensity distribution C1), but is directed to the outer edge of the light L1 (the outer edge of the luminous intensity distribution C1 or the right side edge of the specified range (see FIG. 10B)).

In other words, the lens cuts 2 and 3 are configured such that the peaks of the luminous intensity distributions C2 and C3 of the light L2 and L3 are not coincident with the peak of the luminous intensity distribution C1 of the light L1, but are located at the bottom area of the luminous intensity distribution C1 of the light L1.

In the conventional vehicle lighting device as shown in FIGS. 5 and 6, the luminous intensity (CA+CB) of the light A and B irradiated along the main optical axis of the light source S is excessively high whereas the luminous intensity (CC+CD) of the light C and D irradiated at relatively large angles with respect to the main optical axis CL of the light source S is insufficiently small. The vehicle lighting device of FIG. 7 can prevent or diminish this problem.

In other words, even when a high directivity LED light source S is used, the problem in which the luminous intensity of light irradiated at a relatively large angle with respect to the main optical axis CL of the light source S is insufficiently small, and the luminous intensity of light irradiated along the main optical axis of the light source S is excessively high, can be totally or partially prevented.

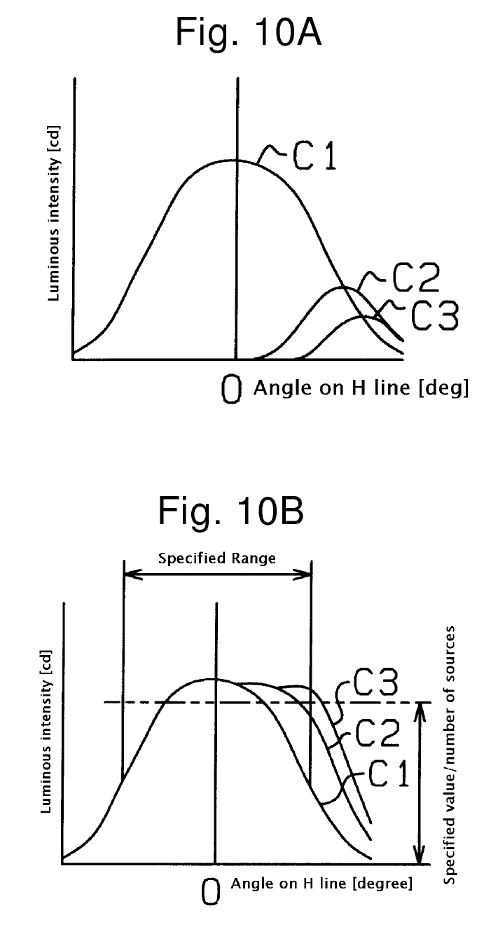

FIG. 11 is a cross sectional view showing the light source S and the lens LS of a vehicle lighting device similar to FIG. 9.

In the vehicle lighting device shown in FIG. 11, light L4′ is emitted from the light source S, and is refracted by means of the lens cut 4 and passes through the lens cut 4 to be irradiated as light L4 in the illumination direction (upward direction in FIG. 11). Specifically, the angle formed between the main optical axis CL and the light L4′ is larger than that formed between the axis CL and the light L1′ (the emission angle within the predetermined range as described above). Furthermore, the angle at which the light L4′ is refracted by means of the lens cut 4 can be larger than that at which the light L1′ is refracted by means of the lens cut 1. In other words, the light L4′ emitted from the light source S at a large angle with respect to the main optical axis CL as compared to that of the light L1′ is more significantly condensed close to the main optical axis CL of the light source S than is the light L1′.

Furthermore, light L5′ is emitted from the light source S, and is refracted by means of the lens cut 5 and passes through the lens cut 5 to be irradiated as light L5 in the illumination direction. Specifically, the angle formed between the main optical axis CL and the light L5′ is larger than that formed between the axis CL and the light L4′. Furthermore, the angle at which the light L5′ is refracted by means of the lens cut 5 can be larger than that at which the light L4′ is refracted by means of the lens cut 4. In other words, the light L5′ emitted from the light source S at a large angle with respect to the main optical axis CL as compared to the light L4′ is more significantly condensed close to the main optical axis CL of the light source S than is the light L4′.

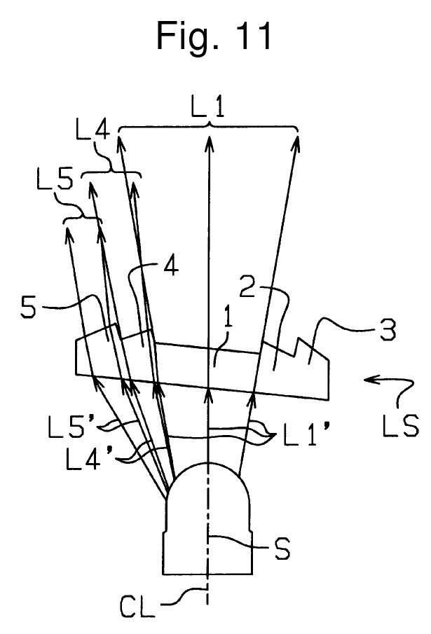

FIGS. 12A and 12B are diagrams illustrating luminous intensity distributions C1, C4, and C5 of light L1, L4, and L5 shown in FIG. 11, respectively. FIG. 12A separately shows the luminous intensity distributions C1, C4, and C5 overlapped with each other. FIG. 12B is a diagram showing a total luminous intensity distribution obtained by synthesizing the luminous intensity distributions C1, C4, and C5.

In these drawings, the vertical axis represents a luminous intensity and the horizontal axis represents a horizontal angle (being an angle on the horizontal line H as shown in FIG. 1) with respect to the main optical axis CL of the light source S (see FIG. 11). For example, zero (0) degree on the horizontal line H corresponds to the points on the main optical axis CL of the light source S.

In the vehicle lighting device, an LED having a high-level directivity is used as a light source S. Accordingly, as shown in FIGS. 4 and 11, as compared to the luminous intensity of the light L1′ which is emitted from the light source S at a relatively small angle (i.e., at emission angles within a predetermined range) with respect to the main optical axis of the light source S, the luminous intensities of the light L4′ and L5′ which are emitted from the light source S at a relatively larger angle with respect to the axis CL are significantly decreased.

As shown in FIG. 11, the lens can have a lens cut 5 formed outside the lens cut 4, and the lens cut 5 can provide a larger condensing degree than that of the lens cut 4. In other words, the relatively low luminous intensity light L4 which has passed through the lens cut 4 is overlapped with the relatively low luminous intensity light L5 which has passed through the lens cut 5. Accordingly, the luminous intensity distribution C4 of the light L4 is overlapped with the luminous intensity distribution C5 of the light L5 as shown in FIG. 12A.

Specifically, the lens cuts 4 and 5 can be configured such that the light L4 which has passed through the lens cut 4 and the light L5 which has passed through the lens cut 5 cross each other. More specifically, the lens cuts 4 and 5 can be configured such that the outer edge of the light L5 which has passed through the lens cut 5 is included within the outer edge of the light L4 which has passed through the lens cut 4. As shown in FIG. 12A, the luminous intensity distribution C5 of the light L5 is located within the area of the luminous intensity distribution C4 of the light L4.

In the conventional vehicle lighting device as shown in FIGS. 5 and 6, the light C with a relatively low luminous intensity which has passed through the lens cut LC3 and the outside light D which also has a relatively low luminous intensity and which has passed through the lens cut LC4 do not overlap with each other for irradiation. Conversely, in the vehicle lighting device of FIG. 11, even when a high directivity LED light source S is used, the light L4 and the light L5 emitted from the light source S with respective large angles with respect to the main optical axis CL can increase the luminous intensity at the area to be irradiated (C4+C5) as shown in FIG. 12B.

Furthermore, one aspect of the vehicle lighting device that can be different from the conventional vehicle lighting devices can be that the width of the lens cut 1 through which the relatively high luminous intensity light L1′ passes can be wider than those of the lens cuts 4 and 5 through which relatively low luminous intensity light L4′ and L5′ pass.

In the conventional vehicle lighting device shown in FIGS. 5 and 6, the high luminous intensity light A and B may enter the boundaries of the adjacent two lens cuts LC1 and LC2. In order to prevent the light from entering these boundaries, in the vehicle lighting device of FIG. 11, the width of the lens cut 1 can be wider than those of the lens cuts 4 and 5.

In the conventional vehicle lighting device as shown in FIGS. 5 and 6, the high luminous intensity light A′ and B′ are incident on the boundary between the adjacent lens cuts LC1 and LC2, and the incident light is irregularly reflected. In this case, the light utilization efficiency is reduced to a certain level. However, in the vehicle lighting device of the exemplary embodiment shown in FIG. 11, this reduction in light utilization efficiency can be prevented or diminished. In other words, as compared to the conventional vehicle lighting device (as shown in FIGS. 5 and 6) in which the widths of the lens cuts LC1 and LC2 are set to be relatively narrow, the utilization efficiency of light L1′ from the light source S can be increased (see FIG. 11).

Furthermore, in the vehicle lighting device of FIG. 11, the lens cuts 4 and 5 are configured such that the light L4 and L5 which has passed through the lens cuts 4 and 5, respectively, is not directed toward the center of the light L1 which has passed through the lens cut 1 (center of the luminous intensity distribution C1), but is directed to the outer edge of the light L1 which has passed through the lens cut 1 (the outer edge of the luminous intensity distribution C1 or the left side edge of the specified range (see FIG. 12B)).

Specifically, the lens cuts 4 and 5 are configured such that the peaks of the luminous intensity distributions C4 and C5 of the light L4 and L5 are not made coincident with the peak of the luminous intensity distribution C1 of the light L1. In this case, the lens cuts 4 and 5 can be configured such that the peaks of the luminous intensity distributions C4 and C5 of the light L4 and L5 are located at the bottom area of the luminous intensity distribution C1 of the light L1, or alternatively, are located at a position at which the luminous intensity of the distribution C1 is the same as the peak values of the distributions C4 and C5.

In the conventional vehicle lighting device as shown in FIGS. 5 and 6, the luminous intensity (CA+CB) of the light A and B irradiated along the main optical axis of the light source S is excessively high, whereas the luminous intensity (CC+CD) of the light C and D irradiated at relatively large angles with respect to the main optical axis CL of the light source S is insufficiently small. The vehicle lighting device of the exemplary embodiment shown in FIG. 11 can prevent or diminish this problem.

In other words, in the vehicle lighting device of FIG. 11, even when a high directivity LED light source S is used, effects such a the luminous intensity of light irradiated at a relatively large angle with respect to the main optical axis CL of the light source S being insufficiently small can be diminished or eliminated, even when the luminous intensity of light irradiated along the main optical axis of the light source S (the luminous intensity in the vicinity of the center of the specified area (see FIG. 12B) is excessively high.

In the light distribution standard for a rear fog light as shown in FIG. 1, the vertical height is less than the horizontal width. Accordingly, if principles of the disclosed subject matter as shown in FIG. 7 are applied to such a rear fog light, even when the LED, which has the abruptly decreased luminous intensity at a large angle with respect to the main optical axis, is used, it is possible to prevent or diminish the luminous intensity from being insufficient at the upper and lower edge areas of the specified range of the light distribution.

In view of this, the light L2 and L3 is directed to the outer edge of the light L1 (the outer edge of the luminous intensity distribution C1 or the right side edge of the specified range (see FIG. 10B)) as shown in FIGS. 9 and 10A and 10B. Furthermore, the light L4 and L5 is directed to the outer edge of the light L1 (the outer edge of the luminous intensity distribution C1 or the left side edge of the specified range (see FIG. 12B)) as shown in FIGS. 11 and 12A and 12B. On the other hand, the light which has passed through the lens cuts 6, 11, and 16 (see FIGS. 7 and 8) is not directed to the upper edge of the specified range (in the vicinity of the position on the “5°U” line in FIG. 1). In addition to this, the light which has passed through the lens cuts 21, 26, and 31 (see FIGS. 7 and 8) is not directed to the lower edge of the specified range (in the vicinity of the position on the “5°D” line in FIG. 1).

Specifically, the light which has passed through the lens cuts 6, 11, and 16 (see FIGS. 7 and 8) is directed to the center of the specified range (in the vicinity of the position on the horizontal line H in FIG. 1). In addition to this, the light which has passed through the lens cuts 21, 26, and 31 (see FIGS. 7 and 8) is directed to the center of the specified range (in the vicinity of the position on the horizontal line H in FIG. 1).

In the above-described vehicle lighting device, the lens cuts 7, 8, 12, 13, 17, and 18 of the right upper area of the lens LS, the lens cuts 22, 23, 27, 28, 32, and 33 of the right lower area of the lens LS, the lens cuts 9, 10, 14, 15, 19, and 20 of the left upper area of the lens LS, and the lens cuts 24, 25, 29, 30, 34, and 35 of the left lower area of the lens LS (see FIGS. 7 and 8) may be provided only with the diffusion function features, but not with the light directing function features.

As a second exemplary embodiment of a vehicle lighting device made in accordance with principles of the disclosed subject matter, part of the lens cuts 7, 8, 12, 13, 17, and 18 of the right upper area of the lens LS, the lens cuts 22, 23, 27, 28, 32, and 33 of the right lower area, the lens cuts 9, 10, 14, 15, 19, and 20 of the left upper area, and the lens cuts 24, 25, 29, 30, 34, and 35 of the left lower area may be provided only with light directing function features.

Specifically, the lens cut 7 of the right upper area of the lens LS and the lens cut 14 of the left upper area may be provided with light directing function features.

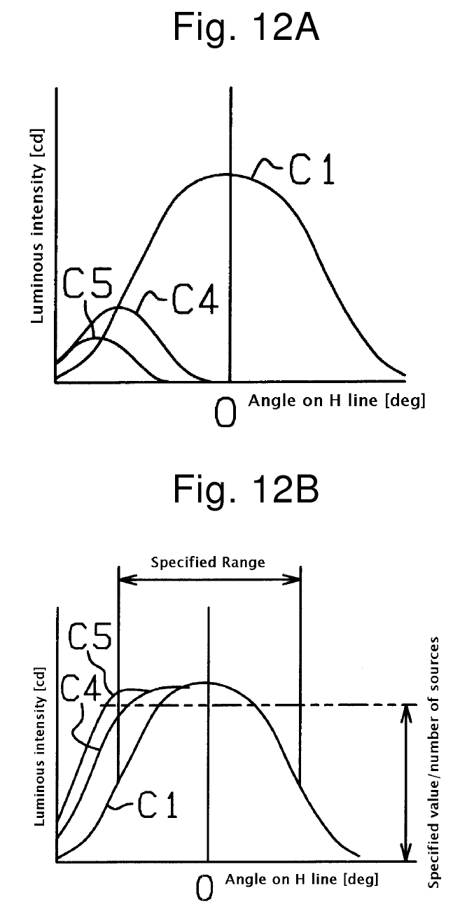

FIG. 13 is a diagram illustrating a luminous intensity distribution of a vehicle lighting device in accordance with the second exemplary embodiment. Specifically, FIG. 13 is a diagram showing a total luminous intensity distribution obtained by synthesizing the respective luminous intensity distributions C1, C2, C3, C4, C5, C7, and C14 of the light which has passed through the lens cuts 1, 2, 3, 4, 5, 7, and 14, respectively. In this drawing, the vertical axis represents a luminous intensity and the horizontal axis represents a horizontal angle (being an angle on the horizontal line H as shown in FIG. 1) with respect to the main optical axis CL of the light source S (see FIG. 7). For example, zero (0) degree on the horizontal line H corresponds to points on the main optical axis CL of the light source S.

In the vehicle lighting device in accordance with the second exemplary embodiment, the light which has passed through the lens cuts 2 and 3, respectively, is directed to the outer edge of the light which has passed through the lens cut 1 (the outer edge of the luminous intensity distribution C1 or the right side edge of the specified range) as shown in FIG. 13. In addition to this, the light which has passed through the lens cut 7 is directed to the outer edge of the light which has passed through the lens cut 1 (the outer edge of the luminous intensity distribution C1 or the right side edge of the specified range). As a result, any insufficient luminous intensity at the outer edge of the luminous intensity distribution C1 (the right side edge of the specified range) can be compensated.

Furthermore, in the vehicle lighting device in accordance with the second exemplary embodiment, the light which has passed through the lens cuts 4 and 5, respectively, is directed to the outer edge of the light which has passed through the lens cut 1 (the outer edge of the luminous intensity distribution C1 or the left side edge of the specified range) as shown in FIG. 13. In addition to this, the light which has passed through the lens cut 14 is directed to the outer edge of the light which has passed through the lens cut 1 (the outer edge of the luminous intensity distribution C1 or the left side edge of the specified range). As a result, any insufficient luminous intensity at the outer edge of the luminous intensity distribution C1 (the right side edge of the specified range) can be compensated.

It should be appreciated that the vehicle lighting device in accordance with the first exemplary embodiment has a single light source S as shown in FIGS. 7 and 8. However, the disclosed subject matter is not limited thereto and may have a plurality of light sources.

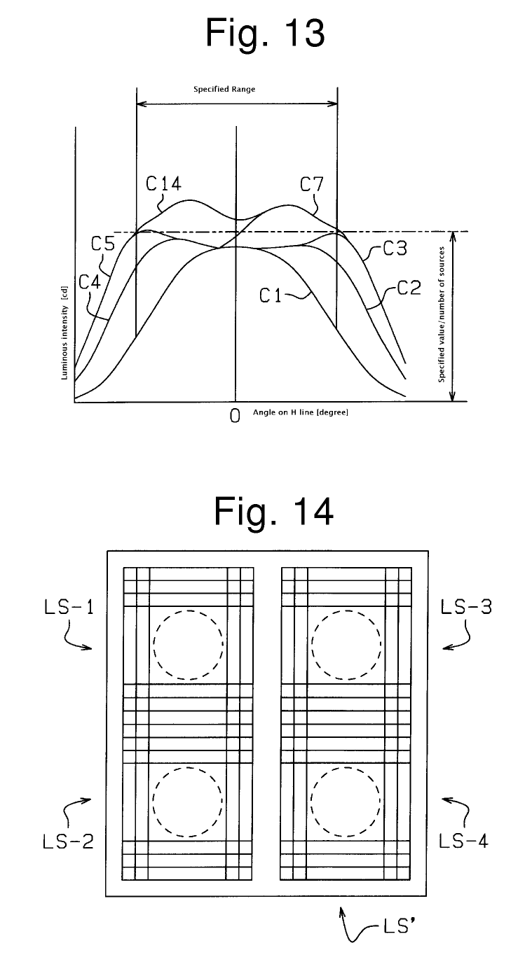

FIG. 14 is a diagram showing a lens LS′ of a vehicle lighting device in accordance with another exemplary embodiment of the disclosed subject matter when viewed from the light source side. In this case, four light sources can be provided (not shown). The lens LS′ may have four lens portions LS-1, LS-2, LS-3, and LS-4 each having the same configuration as that of the lens LS of the vehicle lighting device of FIG. 8.

In the vehicle lighting device of FIG. 14, the light emitted from the light source at a large angle with respect to the main optical axis is condensed close to the main optical axis of the light source S, not by a reflector, but by the lens cut of the lens LS′ located on the main optical axis of the light source.

Accordingly, as compared with the case in which the reflector is used to collect light, the space around the light source can be reduced. Therefore, the lens portions LS-1, LS-2, LS-3, and LS-4 can be located in close proximity to each other.

In other words, the space between adjacent light sources can be narrowed, thereby miniaturizing the entire vehicle lighting device.

Furthermore, in the vehicle lighting device of the exemplary embodiment shown in FIG. 14, a single substrate may be used to support the plurality of light sources.

The disclosed subject matter can facilitate design change as compared to the case where a reflector is used for condensing light in order to make the design suitable for a required or desired luminous intensity distribution.

In the illustrated exemplary embodiments, thirty four (34) lens cuts 2 through 35 are arranged around the lens cut 1. However, the disclosed subject matter is not limited to this description. Alternatively, any number of lens cuts can be arranged around the lens cut 1.

In the illustrated exemplary embodiments, four (4) light sources are used. However, the disclosed subject matter is not limited to this description. Alternatively, any number of light sources can be arranged in line, in matrix, or the like fashion.

The illustrated exemplary embodiments can also be combined appropriately and as desired without departing from the spirit and scope of the disclosed subject matter.

While there has been described what are at present considered to be exemplary embodiments of the disclosed subject matter and invention, it will be understood that various modifications may be made thereto, and it is intended that the appended claims cover such modifications as fall within the true spirit and scope of the invention.

What is claimed is:

1. A lighting device comprising:
a light source having a main optical axis; and
a lens having a first lens cut and a second lens cut formed thereon, the first lens cut configured to allow a first light emitted from the light source to pass therethrough, the first light defined as light emitted at emission angles with respect to the main optical axis located within a predetermined range of emission angles, the second lens cut configured to allow a second light to pass therethrough, the second light defined as light emitted from the light source at emission angles with respect to the main optical axis that are larger than the predetermined range of emission angles for the first light.

2. The lighting device according to claim 1, wherein the second lens cut is configured to provide a larger condensing degree to the second light received from the light source than the first lens cut provides to the first light received from the light source.

3. The lighting device according to claim 1, wherein the lens has a third lens cut formed outside the second lens cut, and the third lens cut is configured to provide a larger condensing degree to light received from the light source than is the second lens cut.

4. The lighting device according to claim 2, wherein the lens has a third lens cut formed outside the second lens cut, and the third lens cut is configured to provide a larger condensing degree to light received from the light source than is the second lens cut.

5. The lighting device according to claim 3, wherein the second and third lens cuts are configured such that the second light that has passed through the second lens cut and a third light that has passed through the third lens cut cross each other.

6. The lighting device according to claim 4, wherein the second and third lens cuts are configured such that the second light that has passed through the second lens cut and a third light that has passed through the third lens cut cross each other.

7. The lighting device according to claim 3, wherein the second and third lens cuts are configured such that an outer edge of the third light that has passed through the third lens cut is included within an outer edge of the second light that has passed through the second lens cut.

8. The lighting device according to claim 4, wherein the second and third lens cuts are configured such that an outer edge of the third light that has passed through the third lens cut is included within an outer edge of the second light that has passed through the second lens cut.

9. The lighting device according to claim 7, wherein the light source is configured to emit a relatively high luminous intensity light around the main optical axis of the light source, and is also configured to emit a lower luminous intensity light as the angle at which the light is emitted with respect to the main optical axis becomes larger, and
wherein a width of the first lens cut through which the relatively high luminous intensity light passes is wider than a width of the second lens cut and a width of the third lens cut through which relatively low luminous intensity light passes.

10. The lighting device according to claim 9, wherein the second and third lens cuts are configured such that the second light and third light that has passed through the second and third lens cuts, respectively, are directed to an outer edge of the first light that has passed through the first lens cut.

11. The lighting device according to claim 10, wherein the second and third lens cuts are configured such that a peak of a luminous intensity distribution curve of the second light and a peak of a luminous intensity distribution curve of the third light are located at second and third positions, respectively, that are different from a peak of a luminous intensity distribution curve of the first light.

12. The lighting device according to claim 1, wherein the lighting device is configured for use as at least one of a vehicle tail light, a vehicle signal light, a vehicle fog light, and a vehicle headlight.

13. A lighting device comprising:
a light source having a main optical axis and configured to emit a first portion of light along the main optical axis and to emit a second portion of light about the first portion of light such that the second portion of light is different from the first portion of light; and
a lens having a first lens portion and a second lens portion configured such that the second lens portion is different from the first lens portion, the first lens portion being configured to intersect with the first portion of light emitted from the light source and to guide the first portion of light along the main optical axis, the second lens portion being configured to intersect with the second portion of light emitted from the light source and to guide the second portion of light towards the main optical axis, wherein at least a portion of the second portion of light is angled towards the main optical axis at an angle greater than any angle of any portion of the first portion of light with respect to and towards the main optical axis.

14. The lighting device according to claim 13, wherein the lens has a third lens portion that is different from both the first lens portion and second lens portion, the third lens portion being configured to intersect with a third portion of light emitted from the light source and to guide the third portion of light towards the main optical axis, wherein at least a portion of the third portion of light is angled towards the main optical axis at an angle greater than any angle of any portion of the second portion of light with respect to and towards the main optical axis.

15. The lighting device according to claim 14, wherein the second lens portion and third lens portion are configured such that the second portion of light that has passed through the second lens portion and the third portion of light that has passed through the third lens portion cross each other.

16. The lighting device according to claim 14, wherein the second lens portion and third lens portion are configured such that an outer peripheral edge of the third portion of light that has passed through the third lens portion is included within an outer peripheral edge of the second portion of light that has passed through the second lens portion.

17. The lighting device according to claim 14, wherein the light source is configured to emit a relatively high luminous intensity light along the main optical axis of the light source, and is also configured to emit a relatively lower luminous intensity light as the angle at which light is emitted from the light source with respect to the main optical axis becomes larger, and
wherein a width of the first lens portion through which the relatively high luminous intensity light passes is wider than a width of the second lens portion and a width of the third lens portion through which relatively lower luminous intensity light passes.

18. The lighting device according to claim 16, wherein the second lens portion and third lens portion are configured such that the second portion of light and third portion of light that has passed through the second and third lens portions, respectively, are directed to an outer edge of the first portion of light that has passed through the first lens portion.

19. The lighting device according to claim 14, wherein the second lens portion and third lens portion are configured such that a peak of a luminous intensity distribution curve of the second portion of light and a peak of a luminous intensity distribution curve of the third portion of light are located at second and third positions, respectively, that are different from a first position of the peak of a luminous intensity distribution curve of the first portion of light.

20. The lighting device according to claim 13, wherein the lighting device is configured for use as at least one of a vehicle tail light, a vehicle signal light, a vehicle fog light, and a vehicle headlight.
